(19) United States
(12) Patent Application Publication
(10) Pub. No.: US 2025/0002683 A1
(43) Pub. Date: Jan. 2, 2025

(54) CURABLE RESIN COMPOSITION, VARNISH, PREPREG, AND CURED PRODUCT

(71) Applicant: HONSHU CHEMICAL INDUSTRY CO., LTD., Chuo-ku, Tokyo (JP)

(72) Inventors: Akihito NASU, Wakayama-shi (JP); Takeru YOSHII, Wakayama-shi (JP); Kentaro WATANABE, Chuo-ku, Tokyo (JP)

(21) Appl. No.: 18/709,664

(22) PCT Filed: Oct. 7, 2022
(86) PCT No.: PCT/JP2022/037637

§ 371 Date: May 13, 2024

(30) Foreign Application Priority Data
Nov. 17, 2021 (JP) 2021-186724

(51) Int. Cl. C08K 5/1515; C08J 5/24; C09D 7/20; C09D 7/63; C09D 171/12

(52) U.S. Cl. CPC C08K 5/1515; C08J 5/243; C08J 5/248; C09D 7/20; C09D 7/63; C09D 171/12; C08J 2371/12

(57) ABSTRACT

A curable resin composition contains (A) a polyphenylene ether resin in an amount of 100 parts by weight and (B) an allyl-containing compound represented by general formula (1) in an amount ranging from 1.5 to 6.0 parts by weight. The curable resin composition is made to overcome problems associated with a curing agent and to provide a prepreg and a cured product having significantly improved heat resistance:

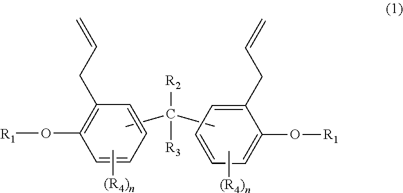

### TECHNICAL FIELD

The present invention relates to a curable resin composition and prepreg for obtaining a cured product having improved heat resistance.

### BACKGROUND ART

Polyphenylene ether (PPE) has a low dielectric constant and a low dielectric loss tangent and thus is known to be suitable as a material for an electronic device such as a printed wiring board. As a substrate material for a printed wiring board, properties such as flame retardance and heat resistance have also been required.

Polyphenylene ether resins are classified as thermoplastic resins and are typically used in combination with curing agents. Triallyl isocyanurate, which is a general-purpose curing agent, is said to be desirably added in an amount as large as 30 wt % or more to a polyphenylene ether resin (NPL 1), but is volatile at around 150° C., at which the polyphenylene ether resin cures; thus, there are problems in that the curing agent volatilizes during heat curing of the polyphenylene ether resin, so that curing performance equivalent to the amount added cannot be provided, and in addition the production apparatus may be contaminated.

On the other hand, the present inventors have confirmed that when triallyl isocyanurate is used as a curing agent for polyphenylene ether, the smaller the amount of triallyl isocyanurate used, the lower the heat resistance of a resulting cured product, as demonstrated by Comparative Examples in EXAMPLES given later.

That is, it has been confirmed again that when triallyl isocyanurate serving as a curing agent is used in a reduced amount, crosslinked portions for resin curing are not formed much, besides volatilization of triallyl isocyanurate results in a further reduction of triallyl isocyanurate that participates in crosslink formation, so that the polyphenylene ether resin cannot be sufficiently cured, and a cured product having desired characteristics cannot be obtained.

Bisphenol compounds having an allyl group, such as diallyl bisphenol A, are used as raw materials of resin materials such as phenol resins, epoxy resins, bismaleimide resins, and polyphenylene ether resins because of having a reactive allyl group.

Compounds derived by modifying a hydroxy group of a bisphenol compound having an allyl group are also used as such raw materials, and it is known, for example, that diallyl bisphenol A having an acetyl group is used as a curing agent for an epoxy resin (PTL 1).

### CITATION LIST

### Patent Literature

PTL 1: International Publication No. 2008/124797

### Non Patent Literature

NPL 1: Japanese Journal of Polymer Science and Technology, 1997, Vol. 54, No. 4, p. 171-182

### SUMMARY OF INVENTION

### Technical Problem

An object of the present invention is to provide a curable resin composition and prepreg for obtaining a cured product having improved heat resistance.

### Solution to Problem

To achieve the above object, the present inventors have conducted intensive studies and found that when a compound having a bisphenol skeleton whose hydroxy group is modified by a substituent and having an allyl group is used as a curing agent for curing of a polyphenylene ether resin, despite being used in an amount extremely smaller than the amount of a conventional curing agent used, a cured product having improved heat resistance can be obtained, thereby completing the present invention.

The present invention is as follows.
1. A curable resin composition containing a component (A) in an amount of 100 parts by weight and a component (B) in an amount ranging from 1.5 to 6.0 parts by weight.
   (A): a polyphenylene ether resin
   (B): an allyl-containing compound represented by general formula (1)

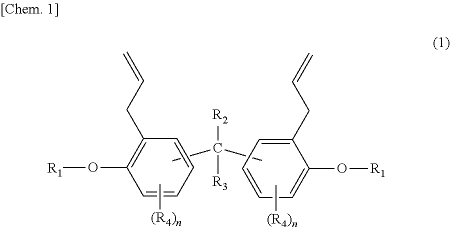

(In the formula, each R₁ independently represents a monovalent functional group substitutable for a hydrogen atom of a hydroxy group, R₂ and R₃ each independently represent a hydrogen atom or a linear or branched alkyl group having 1 to 6 carbon atoms, each R₄ independently represents a linear or branched alkyl group having 1 to 6 carbon atoms, and each n independently represents 0 or an integer of 1 to 3. R₂ and R₃ may be bonded to each other to form a cyclic alkylidene group having 5 to 12 carbon atoms.)
2. The curable resin composition according to 1., wherein each R₁ in general formula (1) is independently a functional group selected from monovalent saturated aliphatic groups, monovalent unsaturated aliphatic groups, monovalent aromatic hydrocarbon groups, monovalent acetal-based substituents, acyl groups, monovalent epoxide-containing groups, and monovalent oxetane-containing groups.
3. The curable resin composition according to 2., wherein each R₁ in general formula (1) is independently a functional group selected from monovalent saturated aliphatic groups having 1 to 8 carbon atoms, monovalent unsaturated aliphatic groups having 1 to 4 carbon atoms, and acyl groups having a total of 2 to 8 carbon atoms.
4. The curable resin composition according to 3., wherein R₂ and R₃ in general formula (1) are each independently a hydrogen atom or a linear or branched alkyl group having 1 to 6 carbon atoms.
5. The curable resin composition according to 3., wherein each R₁ in general formula (1) is independently a functional group selected from an acetyl group, a benzoyl group, an acryloyl group, and a methacryloyl group.
6. The curable resin composition according to 5., wherein each R₁ in general formula (1) is independently a functional group selected from an acetyl group and a benzoyl group.
7. The curable resin composition according to 6., wherein R₂ and R₃ in general formula (1) are each independently a hydrogen atom or a linear or branched alkyl group having 1 to 6 carbon atoms.
8. The curable resin composition according to 1., containing a component (C) in an amount ranging from 0.05 to 1.0 parts by weight.
   (C): a reaction initiator 9. The curable resin composition according to 1, or 8., further containing a component (D).
   (D): a filler
10. A varnish containing the curable resin composition according to 1, and a component (E).
   (E): a solvent
11. A prepreg containing the varnish according to 10. and a component (F).
   (F): a reinforcing fiber
12. A cured product obtained by curing the curable resin composition according to 1.
13. A cured product obtained by curing the prepreg according to 11.

### Advantageous Effects of Invention

The curable resin composition according to the present invention uses an allyl-containing compound represented by general formula (1) in a specific range as a curing agent for curing of a polyphenylene ether resin, the amount of the allyl-containing compound used being extremely smaller than the amount of a conventional curing agent used, and can provide a cured product having excellent physical properties although the amount of the allyl-containing compound used is reduced, and thus can achieve a significant reduction in the cost of the curing agent in the production of a processed product using the polyphenylene ether resin, which is industrially very useful.

In addition, problems such as equipment contamination due to volatilization of the curing agent can be reduced, which is very advantageous also in terms of yield and production efficiency.

### BRIEF DESCRIPTION OF DRAWING

FIG. 1 is a graph showing the relationship of the content of curing agent compound B1 in Examples 1 and 2 and the content of curing agent compound X in Comparative Examples 1 to 4 with the glass transition temperature (Tg) of cured products. Two broken lines in the figure show quadratic polynomial fitted curves of curing agent compound B1 and curing agent compound X.

FIG. 2 is an enlarged graph of a part of the graph of FIG. 1 where the content of curing agent compound B1 or curing agent compound X is in the range of 0 to 10 parts by weight and the glass transition temperature (Tg) is in the range of 170° C. to 210° C.

### DESCRIPTION OF EMBODIMENTS

### <Component (A)>

A curable resin composition according to the present invention contains a polyphenylene ether resin as a component (A), and any polyphenylene ether resin can be used.

Specific examples of such polyphenylene ether resins include poly(2,6-dimethyl-1,4-phenylene ether), poly(2-methyl-6-ethyl-1,4-phenylene ether), poly(2-methyl-6-phenyl-1,4-phenylene ether), poly(2,6-dichloro-1,4-phenylene ether), a copolymer of 2,6-dimethylphenol and another phenol (e.g., 2,3,6-trimethylphenol or 2-methyl-6-butylphenol), a polyphenylene ether copolymer obtained by coupling 2,6-dimethylphenol with a biphenol, a bisphenol, or a trisphenol, and a polyphenylene ether copolymer obtained by coupling 2,6-dimethylphenol and another phenol with a biphenol, a bisphenol, or a trisphenol.

A polyphenylene ether obtained by modifying a terminal hydroxy group of a polyphenylene ether resin with a functional group having an unsaturated double bond, such as allyl ether, acryloyl, methacryloyl, or vinyl ether, may also be used.

### <Component (B)>

The curable resin composition according to the present invention contains, as a component (B), an allyl-containing compound represented by general formula (1). The component (B) in the present invention is a component that functions as a curing agent for curing the polyphenylene ether resin serving as the component (A).

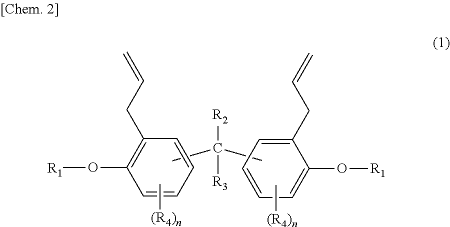

(In the formula, each R₁ independently represents a monovalent functional group substitutable for a hydrogen atom of a hydroxy group, R₂ and R₃ each independently represent a hydrogen atom or a linear or branched alkyl group having 1 to 6 carbon atoms, each R₄ independently represents a linear or branched alkyl group having 1 to 6 carbon atoms, and each n independently represents 0 or an integer of 1 to 3. R₂ and R₃ may be bonded to each other to form a cyclic alkylidene group having 5 to 12 carbon atoms.)

Each R₁ in general formula (1) independently represents a monovalent functional group substitutable for a hydrogen atom of a hydroxy group, examples of which include monovalent saturated aliphatic groups, monovalent unsaturated aliphatic groups, monovalent aromatic hydrocarbon groups, monovalent acetal-based substituents, acyl groups, monovalent epoxide-containing groups, and monovalent oxetane-containing groups, particularly, monovalent saturated aliphatic groups having 1 to 8 carbon atoms, monovalent unsaturated aliphatic groups having 1 to 4 carbon atoms, monovalent aromatic hydrocarbon groups, monovalent acetal-based substituents, acyl groups having a total of 2 to 8 carbon atoms, monovalent epoxide-containing groups, and monovalent oxetane-containing groups, and is a functional group selected from these functional groups.

In particular, each R₁ in general formula (1) is independently preferably a monovalent saturated aliphatic group having 1 to 8 carbon atoms, a monovalent unsaturated aliphatic group having 1 to 4 carbon atoms, or an acyl group having a total of 2 to 8 carbon atoms, more preferably a monovalent unsaturated aliphatic group having 1 to 4 carbon atoms or an acyl group having a total of 2 to 8 carbon atoms, particularly preferably an acyl group having a total of 2 to 8 carbon atoms.

Specific examples of monovalent saturated aliphatic groups having 1 to 8 carbon atoms include a methyl group, an ethyl group, a n-propyl group, a tert-butyl group, a cyclopropylmethyl group, a cyclopentyl group, and a cyclohexyl group. Of these, a methyl group, an ethyl group, a n-propyl group, and a tert-butyl group are preferred.

Specific examples of monovalent unsaturated aliphatic groups having 1 to 4 carbon atoms include a vinyl group and an allyl group. Of these, an allyl group is preferred.

Specific examples of monovalent aromatic hydrocarbon groups include a phenyl group, a benzyl group, and a p-methoxybenzyl group. Of these, a benzyl group is preferred.

Specific examples of monovalent acetal-based substituents include a methoxymethyl group, a 2-tetrahydropyranyl group, and an ethoxyethyl group.

Specific examples of acyl groups having a total of 2 to 8 carbon atoms include an acetyl group, a pivaloyl group, a benzoyl group, an acryloyl group, and a methacryloyl group. Of these, an acetyl group, a benzoyl group, an acryloyl group, and a methacryloyl group are preferred, an acetyl group and a benzoyl group are more preferred, and an acetyl group is particularly preferred.

Specific examples of monovalent epoxide-containing groups include a glycidyl group, which is preferred.

Specific examples of monovalent oxetane-containing groups include a (3-methyloxetan-3-yl)methyl group, which is preferred.

R₂ and R₃ in general formula (1) each independently represent a hydrogen atom or a linear or branched alkyl group having 1 to 6 carbon atoms, and R₂ and R₃ may be bonded to each other to form a cyclic alkylidene group having 5 to 12 carbon atoms.

In particular, R₂ and R₃ are preferably each independently a hydrogen atom or a linear or branched alkyl group having 1 to 4 carbon atoms, more preferably each independently a hydrogen atom or a linear alkyl group having 1 or 2 carbon atoms, still more preferably each independently a hydrogen atom or a methyl group, particularly preferably both methyl groups.

When R₂ and R₃ form a cyclic alkylidene group, the cyclic alkylidene group preferably has 6 to 12 carbon atoms, and more preferably has 6 to 9 carbon atoms. Specific examples of such cyclic alkylidene groups include a cyclopentylidene group (5 carbon atoms), a cyclohexylidene group (6 carbon atoms), a 3-methylcyclohexylidene group (7 carbon atoms), a 4-methylcyclohexylidene group (7 carbon atoms), a 3,3,5-trimethylcyclohexylidene group (9 carbon atoms), a cycloheptylidene group (7 carbon atoms), and a cyclododecanylidene group (12 carbon atoms). Of these, the cyclic alkylidene group is preferably a cyclohexylidene group, a 3-methylcyclohexylidene group, a 4-methylcyclohexylidene group, a 3,3,5-trimethylcyclohexylidene group, or a cyclododecanylidene group, more preferably a cyclohexylidene group, a 3,3,5-trimethylcyclohexylidene group, or a cyclododecanylidene group, particularly preferably a cyclohexylidene group or a 3,3,5-trimethylcyclohexylidene group.

The positions of bonding of a carbon atom to which R₂ and R₃ are bonded to benzene rings are each preferably the para or ortho position with respect to the position where an R₁−O− group is bonded. For the positions of bonding, there are cases where (i) both are the para positions, (ii) both are the ortho positions, and (iii) one is the para position and the other is the ortho position. When R₂ and R₃ are both hydrogen atoms, the compound represented by general formula (1) is preferably a compound in the bonding mode of (i), a compound in the bonding mode of (iii), or a combination of compounds in the bonding modes of (i) to (iii), more preferably a combination of compounds in the bonding modes of (i) to (iii). When R₂ is a hydrogen atom or a linear or branched alkyl group having 1 to 6 carbon atoms and R₃ is a linear or branched alkyl group having 1 to 6 carbon atoms, or when R₂ and R₃ are bonded to each other to form a cyclic alkylidene group having 5 to 12 carbon atoms, the bonding mode of (i) is particularly preferred.

In particular, each R₄ is preferably independently a linear or branched alkyl group having 1 to 4 carbon atoms, more preferably independently a methyl group.

In particular, each n is preferably independently 0, 1 or 2, more preferably 0 or 1, particularly preferably 0.

Specific compounds exemplified as the allyl-containing compound represented by general formula (1) will be described below.

Specific examples of the compound represented by general formula (1) in the case where R₁ in general formula (1) is a monovalent saturated aliphatic group having 1 to 8 carbon atoms and the positions of bonding of a carbon atom to which R₂ and R₃ are bonded to benzene rings are in the bonding mode of (i) above include compounds represented by formulae (1-1) and (1-2) below.

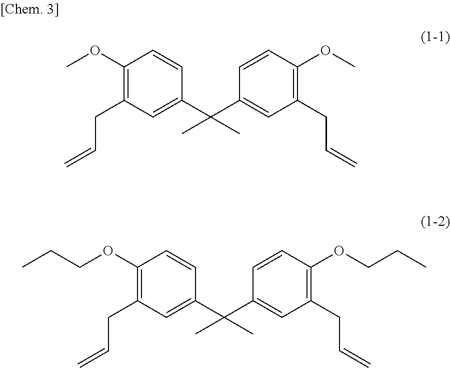

Specific examples of the compound represented by general formula (1) in the case where R₁ in general formula (1) is a monovalent unsaturated aliphatic group having 1 to 4 carbon atoms and the positions of bonding of a carbon atom to which R₂ and R₃ are bonded to benzene rings are in the bonding mode of (i) above include compounds represented by formulae (1-3) and (1-4) below.

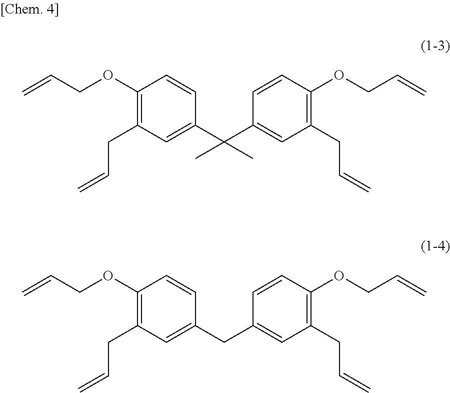

Specific examples of the compound represented by general formula (1) in the case where R₁ in general formula (1) is a monovalent aromatic hydrocarbon group and the positions of bonding of a carbon atom to which R₂ and R₃ are bonded to benzene rings are in the bonding mode of (i) above include a compound represented by formula (1-5) below.

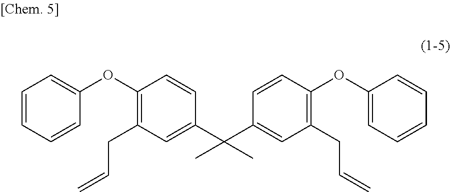

Specific examples of the compound represented by general formula (1) in the case where R₁ in general formula (1) is an acyl group having a total of 2 to 8 carbon atoms and the positions of bonding of a carbon atom to which R₂ and R₃ are bonded to benzene rings are in the bonding mode of (i) above include compounds represented by formulae (1-6), (1-7), (1-8), (1-9), and (1-10) below.

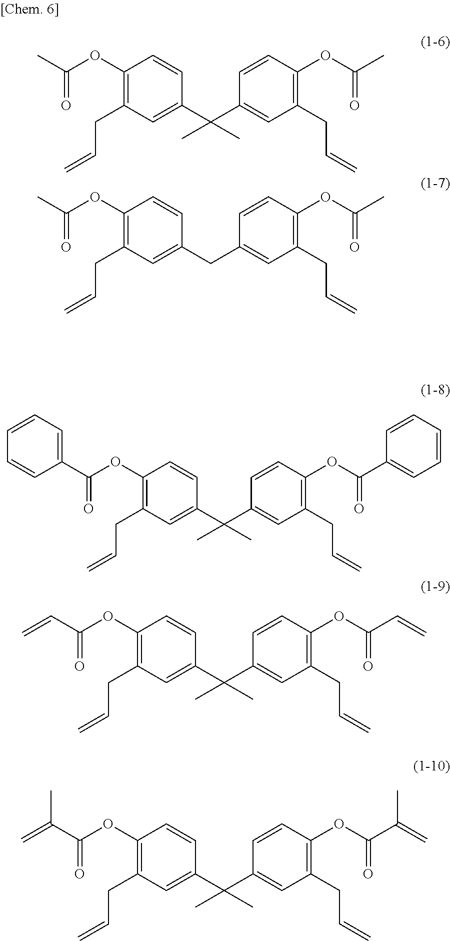

Specific examples of the compound represented by general formula (1) in the case where R₁ in general formula (1) is an epoxide-containing group and the positions of bonding of a carbon atom to which R₂ and R₃ are bonded to benzene rings are in the bonding mode of (i) above include a compound represented by formula (1-11) below.

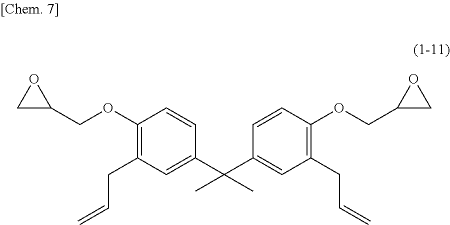

The curable resin composition according to the present invention contains, as the component (B), the allyl-containing compound represented by general formula (1) in an amount ranging from 1.5 to 6.0 parts by weight relative to 100 parts by weight of the component (A).

The content of the component (B) is preferably in the range of 2.0 to 6.0 parts by weight, more preferably in the range of 2.5 to 5.8 parts by weight, still more preferably in the range of 2.5 to 5.7 parts by weight, relative to 100 parts by weight of the component (A).

The curable resin composition according to the present invention uses the component (B) in an amount extremely smaller than the amount of a conventional curing agent used and can provide a cured product having excellent physical properties although the amount of the component (B) used is reduced. In addition, as compared with curable resin compositions of the related art, the content ratio of the polyphenylene ether resin, whose dielectric constant and dielectric loss tangent are low, can be increased, and thus when the curable resin composition is used as, for example, a substrate material for a printed wiring board, it is expected that a printed wiring board having excellent electrical properties can be obtained.

### <Component (C)>

The curable resin composition according to the present invention preferably contains a reaction initiator as a component (C) in addition to the component (A) and the component (B). The component (C) is added to accelerate the crosslinking reaction of the curable resin composition containing the component (A) and the component (B).

The component (C) is not particularly limited as long as it accelerates the crosslinking reaction, and examples include ionic catalysts such as imidazoles, tertiary amines, quaternary ammonium salts, boron trifluoride amine complexes, organophosphines, and organophosphonium salts; and radical polymerization initiators such as organic peroxides, hydroperoxide, and azoisobutyronitrile. Of these, organic peroxides are preferably used.

Examples of organic peroxides include aliphatic organic peroxides such as di-t-butyl peroxide, dilauroyl peroxide, 2,5-dimethyl-2,5-di(t-butylperoxy)hexane, 2,2-bis (t-butylperoxy)butane, 2,2-bis(t-butylperoxy)octane, 2,5-dimethyl-2,5-bis(t-butylperoxy)hexyne, and di-n-propyl peroxydicarbonate; and aromatic organic peroxides including an aromatic ring such as dibenzoyl peroxide, dicumyl peroxide, t-butyl peroxybenzoate, t-amyl peroxybenzoate, t-butylcumyl peroxide, bis (1-t-butylperoxy-1-methylethyl)benzene, 2-phenyl-2-[(2-phenylpropan-2-yl)peroxy]propane, α,α′-di(t-butylperoxy)diisopropylbenzene, α,α′-bis(t-butylperoxy-m-isopropyl)benzene, and di-t-butylperoxy isophthalate. Of these, aromatic organic peroxides are preferably used.

Among the aromatic organic peroxides, dicumyl peroxide, t-butylcumyl peroxide, bis(1-t-butylperoxy-1-methylethyl)benzene, and 2-phenyl-2-[(2-phenylpropan-2-yl)peroxy]propane are more preferred, and 2-phenyl-2-[(2-phenylpropan-2-yl)peroxy]propane is particularly preferred.

The curable resin composition according to the present invention contains the component (C) preferably in an amount ranging from 0.05 to 0.9 wt %, more preferably in an amount ranging from 0.15 to 0.8 wt %, still more preferably in an amount ranging from 0.3 to 0.7 wt %, particularly preferably in an amount ranging from 0.35 to 0.6 wt %, relative to the total amount of the curable resin composition.

One component (C) may be used alone, or two or more components (C) may be used in combination.

### <Component (D)>

The curable resin composition according to the present invention preferably contains a filler as a component (D) in addition to the component (A), the component (B), and optionally the component (C).

The component (D) is preferably contained in an amount ranging from 10 to 150 parts by weight, and is more preferably contained in an amount ranging from 10 to 100 parts by weight, relative to 100 parts by weight of the curable resin composition.

The component (D) is not particularly limited as long as it is a filler commonly used in a curable resin composition. For example, inorganic fillers such as silicon oxide, aluminum oxide, magnesium oxide, boron nitride, aluminum nitride, silicon nitride, silicon carbide, and hexagonal boron nitride can be used as a mixture.

### <Component (E)>

The curable resin composition according to the present invention may contain a solvent as a component (E). In particular, the curable resin composition is preferably dissolved or dispersed in the component (E) to be in the form of a varnish.

The component (E) is not particularly limited as long as it dissolves or disperses the curable resin composition according to the present invention, and examples include aromatic compounds such as toluene and xylene; ketone compounds such as methyl ethyl ketone, cyclopentanone, and cyclohexanone; and chlorinated organic solvents such as chloroform.

Of these, aromatic compounds such as toluene and xylene and ketone compounds such as methyl ethyl ketone, cyclopentanone, and cyclohexanone are preferred, aromatic compounds such as toluene and xylene are more preferred, and toluene is particularly suitable.

The component (E) is preferably contained in an amount ranging from 50 to 200 parts by weight, and is more preferably contained in an amount ranging from 70 to 150 parts by weight, relative to 100 parts by weight of the curable resin composition.

The method of preparing the curable resin composition according to the present invention is not particularly limited, and one example is a method involving mixing the above-described components and mixing or dispersing them with a stirrer.

### <Prepreg>

A prepreg according to the present invention can be a thin-film prepreg of a curable resin composition formed by casting the curable resin composition containing the component (A) and the component (B) and the varnish containing a solvent serving as the component (E) on a support such as a polyimide or polyester film or a glass substrate, followed by drying.

Alternatively, the prepreg according to the present invention can be a prepreg formed by mixing the curable resin composition containing the component (A) and the component (B) and the varnish containing a solvent serving as the component (E) with a reinforcing fiber serving as a component (F). Examples of methods for the mixing include application of the varnish to the reinforcing fiber serving as the component (F) and impregnation of the reinforcing fiber with the varnish.

### <Component (F)>

The component (F) in the present invention is not particularly limited as long as it is a reinforcing fiber commonly used for a prepreg. For example, various inorganic fibers and organic fibers such as carbon fiber, aramid fiber, nylon fiber, high-strength polyester fiber, glass fiber, boron fiber, alumina fiber, and silicon nitride fiber can be used. Of these, carbon fiber, aramid fiber, glass fiber, boron fiber, alumina fiber, and silicon nitride fiber may be used from the viewpoint of specific strength and specific modulus. In particular, carbon fiber is preferred from the viewpoint of mechanical properties and weight saving. When carbon fiber is used as the reinforcing fiber, it may be subjected to surface treatment with metal.

The thickness of a fiber substrate is preferably 0.3 mm or less, more preferably 0.15 mm or less, still more preferably 0.1 mm or less.

One component (F) may be used alone, or two or more components (F) may be used in combination.

### <Method for Producing Cured Product>

A cured product according to the present invention can be obtained by curing the curable resin composition according to the present invention.

Examples of methods for producing the cured product according to the present invention include a method in which the above prepreg is cured by heating to a predetermined temperature, and a method in which the curable resin composition according to the present invention is cured by heating to a predetermined temperature after, for example, being filled into a mold or the like or being melted by heating and injected into a mold or the like.

The heat-curing temperature can be appropriately determined in the range of 105° C. to 270° C.

### EXAMPLES

The present invention will now be described more specifically with reference to Examples, but it should be noted that the present invention is not limited to these Examples.

Analysis methods in the present invention are as follows.

### <Analysis Methods>

(1) Evaluation of heat resistance of curing agent: 5% weight loss temperature measurement

The heat resistance of compounds used as curing agents was evaluated by measuring the 5% weight loss temperature of each compound with the following apparatus under the following conditions.
Apparatus: DTG-60A/manufactured by Shimadzu Corporation
Temperature: 30° C.→400° C. (heating rate, 10° C./min)
Measurement atmosphere: open; nitrogen, 50 mL/min
Sample weight: 8 to 12 mg
Sample container material: aluminum
(2) Evaluation of heat resistance of cured product of curable resin composition: glass transition temperature (Tg)

A resin film obtained by curing a curable resin composition was measured using the following apparatus under the following conditions, and a glass transition temperature (Tg) was calculated from the intersection of tangent lines drawn by extrapolation before and after the inflection point.
Apparatus: TMA7100 manufactured by Hitachi High-Tech Science Corporation
Sample size: width, 3 mm; length, 20 mm
Conditions: nitrogen atmosphere; load, 200 mN; temperature range, 30° C. to 300° C.; heating rate, 4° C./min
Measurement mode: tensile

### <Evaluation of Heat Resistance of Curing Agent>

The evaluation of heat resistance of curing agent compounds used in Examples and Comparative Examples described later was performed by the method described above.

The curing agent used in Examples is a compound represented by formula (1-6) (propane-2,2′-diyl(2-allyl-4,1-phenylene) diacetate: hereinafter referred to as “compound B1”), and the curing agent used in Comparative Examples is triallyl isocyanurate (hereinafter referred to as “compound X”).

The 5% weight loss temperature is shown in Table 1 as the result of evaluation of heat resistance of curing agent compound B1 and curing agent compound X.

TABLE 1

| | 5% weight loss |
|---|---|
| Curing agent | temperature (° C.) |
| Compound B1 | 211 |
| Compound X | 176 |

As shown in Table 1, it has become clear that curing agent compound B1 used in Examples 1 and 2 and Comparative Example 1, which is the component (B) in the present invention, has higher heat resistance than curing agent compound X (triallyl isocyanurate) used in Comparative Examples 2 to 4.

In a situation of high-temperature heating at about 200° C. for curing a curable resin composition forming a prepreg, curing agent compound X (triallyl isocyanurate) undergoes a weight loss of 5% or more and thus has been confirmed to cause a problem due to volatilization of the curing agent component. On the other hand, it has become clear that the compound of the present invention has high heat resistance and thus can contribute to suppressing the problem due to volatilization of the curing agent component.

### Comparative Example 1

### Preparation of Prepreg

Poly(2,6-dimethyl-1,4-phenylene ether) (the component (A)) in an amount of 100 parts by weight, toluene (the component (E)) in an amount of 100 parts by weight, curing agent compound B1 (the component (B) in the present invention) serving as a curing agent in an amount of 37.1 parts by weight, which was larger than the amount of the component (B) in the present invention, and dicumyl peroxide (peroxide, manufactured by NOF Corporation: trade name “PERCUMYL D”) serving as a reaction initiator (the component (C)) in an amount of 0.68 parts by weight were mixed and stirred with a magnetic stirrer at room temperature to prepare a varnish.

The varnish was applied to a 20-cm square polyimide film (manufactured by UBE Corporation: trade name “UPILEX”) so as to be 0.2 mm thick. Thereafter, from the varnish dried at room temperature to be a semi-cured product, the solvent was removed at 105° C. for 1 hour with a vacuum dryer, thereby obtaining a prepreg of the semi-cured product.

### Preparation of Resin Film

An aluminum foil (0.12 mm thick) frame provided with a 9 cm×4 cm opening was sandwiched on both sides by the prepreg, further sandwiched on both sides by two other polyimide films, and sandwiched on both sides by 25 cm×25 cm metal plates. The resultant was then cured by pressing with a vacuum hot-press machine (manufactured by Toyo Seiki Co., Ltd.) under the following temperature, pressure, and time conditions (heating temperature, 105° C.; pressure, 10 MPa; 30 minutes→heating temperature, 150° C.; pressure, 10 MPa; 1 hour→heating temperature, 200° C.; pressure, 10 MPa; 1 hour→heating temperature, 250° C.; pressure, 10 MPa; 1 hour→heating temperature, 270° C.; pressure, 10 MPa; 1 hour). The polyimide film attached to the resulting cured product was removed to obtain a resin film of Comparative Example 1.

The glass transition temperature (Tg) of the resin film of Comparative Example 1 obtained was measured by the above-described method to evaluate heat resistance. The result is shown in Table 2.

### Examples 1 and 2

A prepreg and a resin film were prepared in the same manner as in “Comparative Example 1” above except that the curing agent “compound B1” was used in an amount of 5.5 parts by weight (Example 1) and 2.8 parts by weight (Example 2), and the evaluation of heat resistance was performed. The result of the evaluation, that is, the glass transition temperature (Tg), is shown in Table 2.

### Comparative Examples 2 to 4

A prepreg and a resin film were prepared in the same manner as in “Comparative Example 1” above except that instead of the curing agent “compound B1”, curing agent compound X (triallyl isocyanurate) was used in an amount of 7.9 parts by weight (Comparative Example 2), 3.6 parts by weight (Comparative Example 3), and 0.9 parts by weight (Comparative Example 4), and the evaluation of heat resistance was performed. The result of the evaluation, that is, the glass transition temperature (Tg), is shown in Table 2.

TABLE 2

| | Curable resin composition (parts by weight) | | | | Cured |
|---|---|---|---|---|---|
| | | Curing agent | | | product |
| | Component | Component (B) | | Component | Tg |
| | (A) | Compound B1 | Compound X | (C) | (° C.) |
| Comparative | 100 | 37.1 | — | 0.68 | 111.9 |
| Example 1 | | | | | |
| Example 1 | 100 | 5.5 | — | 0.68 | 200.9 |
| Example 2 | 100 | 2.8 | — | 0.68 | 199.9 |
| Comparative | 100 | — | 7.9 | 0.68 | 209.0 |
| Example 2 | | | | | |
| Comparative | 100 | — | 3.6 | 0.68 | 181.0 |
| Example 3 | | | | | |
| Comparative | 100 | — | 0.9 | 0.68 | 178.0 |
| Example 4 | | | | | |

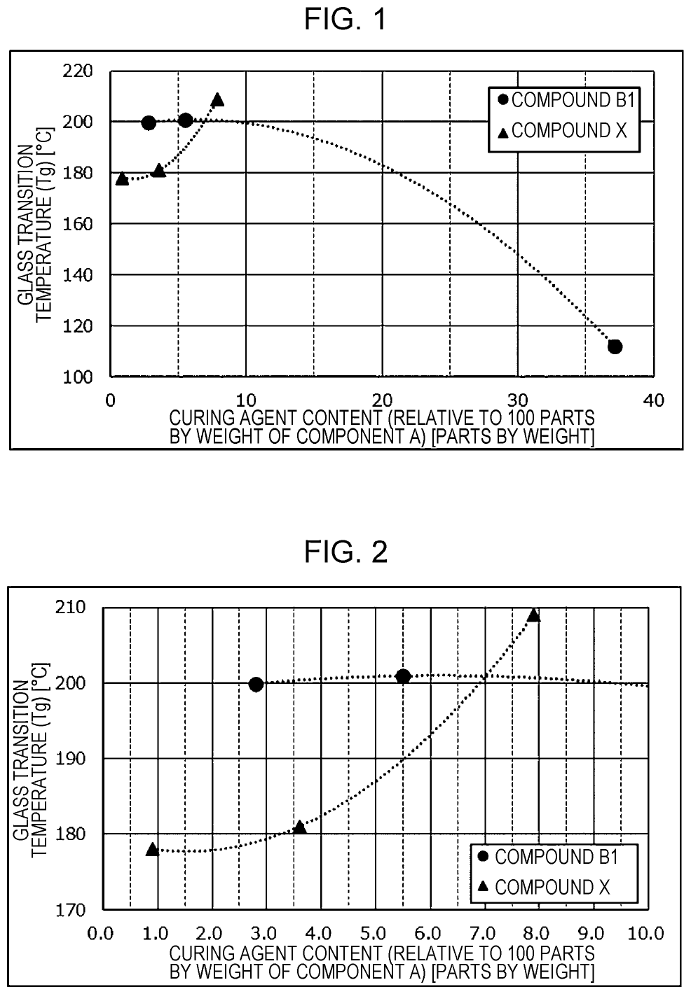

FIG. 1 and FIG. 2 show graphs showing the relationship of the content of compound B1 serving as the component (B), which is a curing agent in Examples 1 and 2 and Comparative Example 1, and the content of compound X, which is a curing agent in Comparative Examples 2 to 4, with the glass transition temperature (Tg) of cured products obtained. Two broken lines in FIGS. 1 and 2 show quadratic polynomial fitted curves of the curing agents, compound B1 and compound X. FIG. 2 is an enlarged graph of a part of the graph of FIG. 1 where the content of curing agent compound B1 or curing agent compound X is in the range of 0 to 10 parts by weight and the glass transition temperature (Tg) is in the range of 170° C. to 210° C.

In Examples 1 and 2, which are specific examples of the curable resin composition according to the present invention, the allyl-containing compound represented by general formula (1) as the component (B) is contained in specific amounts (5.5 parts by weight and 2.8 parts by weight) as a curing agent for curing of the polyphenylene ether resin serving as the component (A). Comparison of Examples 1 and 2 with Comparative Examples 3 and 4, in which “compound X” (triallyl isocyanurate) which is a conventional curing agent is used in more or less the same amounts (3.6 parts by weight and 0.9 parts by weight), in terms of the glass transition temperature (Tg) of cured products obtained shows that the glass transition temperatures of Examples 1 and 2 are higher by about 20° C., confirming that a cured product having high heat resistance can be obtained.

That is, the curable resin composition according to the present invention produces such an extremely remarkable effect that a cured product having high heat resistance can be obtained even though the content of the component (B) serving as a curing agent is in the range of 1.5 to 6.0 parts by weight, which is extremely smaller than the amount of a conventional curing agent used, relative to 100 parts by weight of the polyphenylene ether resin serving as the component (A).

As shown by the results of Comparative Examples 2 to 4 in Table 2, it has become clear that as the amount of “compound X” (triallyl isocyanurate), which is a conventional curing agent, used increases, the glass transition temperature (Tg) of the cured product tends to increase.

By contrast, as is clear from FIGS. 1 and 2 (particularly, FIG. 2), the effect of raising the glass transition temperature (Tg) of a cured product produced by the component (B) in the present invention peaks at the upper limit of the content of the component (B) in the curable resin composition according to the present invention, confirming that this tendency is very different from that of the conventional curing agent (compound X: triallyl isocyanurate) whose amount used and effect on raising the glass transition temperature (Tg) are proportional to each other.

That is, it has become clear that the curable resin composition according to the present invention, in a range where the allyl-containing compound represented by general formula (1) as the component (B) is added in a small amount in a specific range, produces an extremely excellent effect of raising the glass transition temperature (Tg) and provides remarkable heat resistance as compared with the curable resin composition containing the conventional curing agent.

This effect enables a significant reduction in the cost of the curing agent in the production of a processed product using a polyphenylene ether resin, which is industrially very useful. Furthermore, problems such as equipment contamination due to volatilization of the curing agent can be reduced, which is very advantageous also in terms of yield and production efficiency.

In addition, in the curable resin composition according to the present invention, as compared with polyphenylene ether resin-containing curable resin compositions of the related art, the content ratio of the polyphenylene ether resin, whose dielectric constant and dielectric loss tangent are low, can be increased, and thus when the curable resin composition is used as, for example, a substrate material for a printed wiring board, it is expected that a printed wiring board having excellent electrical properties can be obtained.

1. A curable resin composition comprising a component (A) in an amount of 100 parts by weight and a component (B) in an amount ranging from 1.5 to 6.0 parts by weight:
(A): a polyphenylene ether resin
(B): an allyl-containing compound represented by general formula (1) 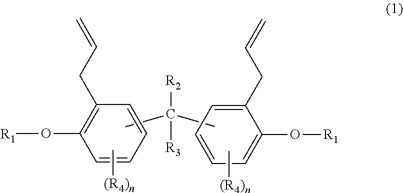
where each R₁ independently represents a monovalent functional group substitutable for a hydrogen atom of a hydroxy group, R₂ and R₃ each independently represent a hydrogen atom, a linear alkyl group having 1 to 6 carbon atoms, or a branched alkyl group having 3 to 6 carbon atoms, each R₄ independently represents, a linear alkyl group having 1 to 6 carbon atoms, or a branched alkyl group having 3 to 6 carbon atoms, each n independently represents 0 or an integer of 1 to 3, and R₂ and R₃ may be bonded to each other to form a cyclic alkylidene group having 5 to 12 carbon atoms.

2. The curable resin composition according to claim 1, wherein each R₁ in general formula (1) is independently a functional group selected from monovalent saturated aliphatic groups, monovalent unsaturated aliphatic groups, monovalent aromatic hydrocarbon groups, monovalent acetal-based substituents, acyl groups, monovalent epoxide-containing groups, and monovalent oxetane-containing groups.

3. The curable resin composition according to claim 2, wherein each R₁ in general formula (1) is independently a functional group selected from monovalent saturated aliphatic groups having 1 to 8 carbon atoms, monovalent unsaturated aliphatic groups having 1 to 4 carbon atoms, and acyl groups having a total of 2 to 8 carbon atoms.

4. The curable resin composition according to claim 3, wherein R₂ and R₃ in general formula (1) are each independently a hydrogen atom, a linear alkyl group having 1 to 6 carbon atoms, or a branched alkyl group having 3 to 6 carbon atoms.

5. The curable resin composition according to claim 3, wherein each R₁ in general formula (1) is independently a functional group selected from an acetyl group, a benzoyl group, an acryloyl group, and a methacryloyl group.

6. The curable resin composition according to claim 5, wherein each R₁ in general formula (1) is independently a functional group selected from an acetyl group and a benzoyl group.

7. The curable resin composition according to claim 6, wherein R₂ and R₃ in general formula (1) are each independently a hydrogen atom, a linear alkyl group having 1 to 6 carbon atoms, or a branched alkyl group having 3 to 6 carbon atoms.

8. The curable resin composition according to claim 1, comprising a component (C) in an amount ranging from 0.05 to 1.0 parts by weight:
(C): a reaction initiator.

9. The curable resin composition according to claim 1, further comprising a component (D);
(D): a filler.

10. A varnish comprising the curable resin composition according to claim 1 and a component (E);
(E): a solvent.

11. A prepreg comprising the varnish according to claim 10 and a component (F):
(F): a reinforcing fiber.

12. A cured product obtained by curing the curable resin composition according to claim 1.

13. A cured product obtained by curing the prepreg according to claim 11.

14. The curable resin composition according to claim 8, further comprising a component (D):
(D): a filler.
